(19) United States
(12) Patent Application Publication
(10) Pub. No.: US 2004/0154299 A1
(43) Pub. Date: Aug. 12, 2004

(54) Micro solar thermal power system

(76) Inventors: Kari Appa, Lake Forest, CA (US); Suri Narayan Appa, Lake Forest, CA (US)

Correspondence Address: Dr. Kari Appa, 22242 Anthony Drive, Lake Forest, CA, 92630, US

(21) Appl. No.: 10/360,348

(22) Filed: Feb. 10, 2003

(51) Int. Cl. F03G 6/00; F03G 7/00; B60L 8/00; B60K 16/00

(52) U.S. Cl. 60/641.8; 60/641.11

(57) ABSTRACT

The present invention relates generally to the design and fabrication of a micro solar electric power generating apparatus and, more particularly, a method of using microsolar thermal jets to produce electrical power by economical means for residential and commercial buildings. A simple rotary jet engine has been developed to drive an electrical generator. A hybrid solar concentrator that combines the benefit of both parabolic dish and trough has been used to raise the enthalpy of the working fluid without having end thermal flux leakage that is common to the conventional troughs.

### BACKGROUND OF THE INVENTION

1. Field of the Invention

The present invention relates generally to the design of a micro solar thermal electric power generation device and, more particularly, to a method of using micro steam thrust engines to produce electrical power by economical means for residential and commercial buildings.

2. Description of Prior Art

Among many of the renewable energy resources, wind and solar thermal energy means require least expensive energy conversion apparatus. While wind farms are confined to certain specific zones, the solar energy source is available at all places and during all seasons. This opportunity can best be utilized to harness the naturally available solar energy. Parabolic trough and dish concentrators are used to heat the working fluids. Troughs use line concentration to raise the steam temperature in the tube to around 400° C., while the dishes use point concentration, thereby enabling the steam temperature in the spherical boiler to reach well above 1000° C. Power conversion is effected by means of either the Stirling (piston) engine or the Brayton (turbine) engine. Stirling engines use hydrogen or helium as the working fluid medium at pressure around 20 mega Pascal, and temperature in the neighborhood of 700° C. Brayton engines use steam or any other fluid at similar pressures and temperatures. These engines are seen to produce thermal efficiency around 25 to 30 percent.

Extensive research and product development activities have been conducted under the sponsorship of California Energy Commission (NICE³) and the US Department of Energy. U.S. Pat. No. 4, 249,514; to Andrew Jones discloses a tracking solar energy concentrator, in which individually curved mirror slats arranged on a truss-type support structure to collectively form a substantially accurate surface for concentration. The concentrator is rotatably mounted to track the position of the sun. U.S. Pat. No. 4,164,123 issued to Otto Smith discloses a solar thermal electric power-generating device, in which a double paned glass window containing circulating liquid is used as the solar heat receptor. Low pressure and high-pressure turbines are used to convert thermal energy to electrical energy. U.S. Pat. No. 4,171,617 issued to Takeshi Sakamoto et. al. discloses a solar thermal electric system, in which a solar collector, a heat storage vessel filled with a thermal storage material adapted to effect a phase change between solid and liquid internally, and a turbine. Plurality of control valves is provided to manage heat flow through various sections of the power plant in order to increase the thermal efficiency of the system.

U.S. Pat. No. 5,660,038 issued to Joseph Stone discloses a rotary jet engine having intake and exhaust zones separated from each other. At least one combustion chamber is mounted on a rotor having an intake spaced from the axis of rotation, while exhaust jet causes rotation of the rotor.

SUN-LAB at Sandia's National solar thermal test facility has developed Advanced Dish Development System (ADDS) under the project SOLO 161. Stirling engine was used to convert steam energy to electrical energy. These and other studies around the world (e. g. France, England, Germany, Australia) have resulted in the development of improved solar energy concentrators and absorbers, and steam turbine and Stirling engines that convert steam energy to electric energy.

The mathematician and inventor Hero, who is believed to have lived in Alexandria between 150 BC and 50 AD, disclosed the earliest steam jet powered mechanical device. His writings, in Greek, concern the studies of mechanics and pneumatics. They include nearly 80 ingenious inventions such as siphons, fountains, and engines. Newton experimented with it to prove his third law of motion. Friedrich von Doblhoff used the first jet assisted rotor technology based on the Hero's principle in helicopter design in 1940. Later Hiller used the same idea to build helicopter cranes for the US military. U.S. Pat. No. 6,127,739 issued to Appa discloses a jet assisted contra rotating wind turbine system designed to enhance power conversion efficiency utilizing blade tip mounted jet thrusters and counter rotation of tandem rotors.

U.S. Pat. Nos. 6,223,521, 6,233,918 and 6,263,660 B1 to Lawlor disclose a method of generating utility scale power system using ramjets mounted at the periphery of a disc that spins at supersonic speeds. The thermodynamic advantage is achieved by the ram-compression of the inlet air-fuel mixture.

Generally above mentioned solar thermal power conversion studies are confined to large-scale electrical power generation systems, and hence very little importance is given to residential or commercial buildings. Moreover, a micro version of these engines becomes uneconomical for residential use. Hence, there is a need to develop a simple and economical device to convert solar thermal energy to electrical power, which has now been disclosed in the present invention. It was with the knowledge of the foregoing state of the technology that the present invention has been conceived and is now reduced to practice.

### SUMMARY OF THE INVENTION

The present invention describes a method of designing and manufacturing an environmentally friendly micro solar thermal power conversion apparatus that could provide electrical power and cooling for residential and commercial buildings in hot summer days. Said apparatus comprises:

1. A solar heat concentrator to that heats a two phase working fluid to change its phase from liquid to gas,

2. Plurality of micro steam thrust engines mounted at the rim of a spinning disc that produces torque to drive an electrical generator,

3. An electrical generator having a rotor and a stator and produces electrical energy

4. A supporting framework having an enclosure that collects exhaust steam and condenses steam or regeneratively recycles steam,

5. A coaxial shaft that conveys steam and water, and firmly fixed to said disc,

6. A multi-port rotary fluid coupler to convey steam and water to micro jet engines,

7. A pump to transfer water from low pressure condenser to high pressure steam vessel mounted at the focus of the solar collector,

8. A power electronic system that converts variable frequency power to standard domestic volt and frequency.

Micro Steam Thrust Engine:

The solar thermal steam jet engine of the present invention comprises plurality of coaxial nozzles having an inner cone for the expanding steam jet and an outer cone for mixing water with steam jet. The steam jet while expanding to a low-pressure chamber converts its total enthalpy to kinetic energy resulting in a supersonic jet, and generates high decibel noise. To suppress this noise the jet velocity needs to be reduced by adding water and without reducing thrust. The steam jet creates sufficient succession to draw water from the condenser. Thus, the solar thermal energy could be converted to generate torque and in turn electrical energy.

Power Generation:

A rotatably mounted disc having plurality of steam jet nozzles fixed on to its periphery. A is co-axial shaft rotatably mounted on a supporting framework conveys steam and water to said nozzles that cause thrust and torque to propel an electrical generator. Thus solar thermal energy can be converted to electrical energy. As the high enthalpy steam expands through said nozzles, condenses to water. The same water is pumped back to the steam vessel by means of a pump. Thus, a micro solar thermal power generating system could be fabricated and used in residential and commercial buildings to supplement the power in hot summer days.

Other features and benefits of the invention will become apparent in the following description taken in conjunction with the following drawings. It is to be understood that the foregoing general description and the following detailed description are exemplary and explanatory but are not to be restrictive of the invention. The accompanying drawings which are incorporated in and constitute a part of this invention, illustrate one of the embodiments of the invention, and together with the description, serve to explain the principles of the invention in general terms. Like numerals refer to like parts throughout the disclosure.

### BRIEF DESCRIPTION OF THE DRAWINGS

The foregoing aspects and other features of the present invention are explained in the following description, taken in connection with the accompanying drawings, wherein:

### 1. TITLE OF THE DRAWINGS

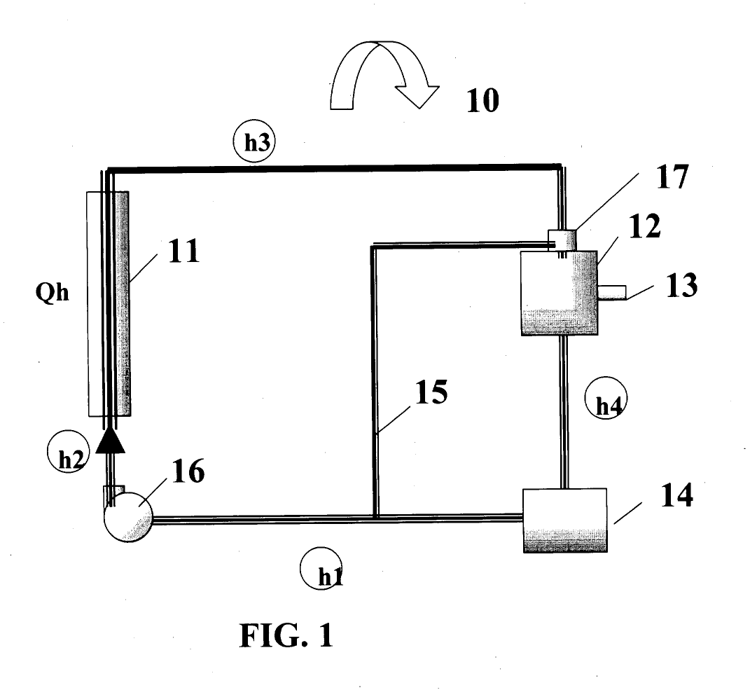

FIG. 1 is a perspective view of a Micro Solar Thermal Power Conversion System

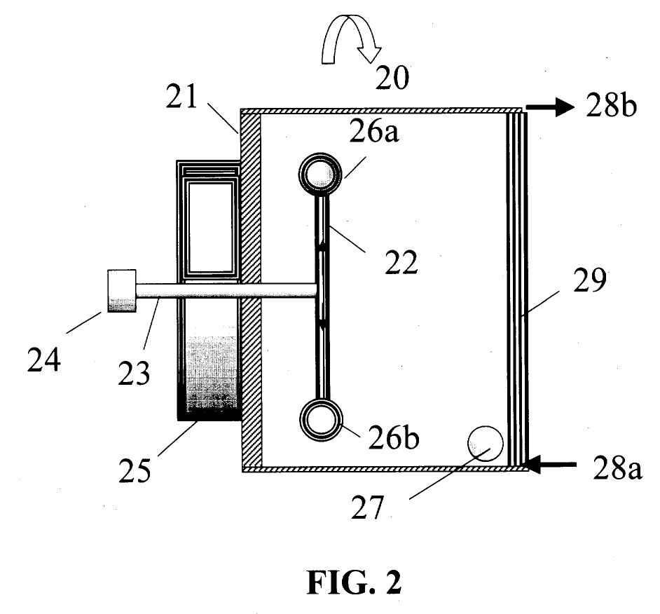

FIG. 2 is a perspective view of a Micro Steam Jet Power Generating Unit,

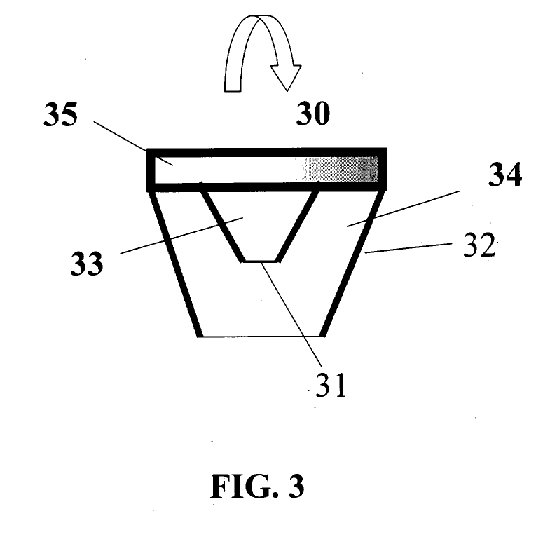

FIG. 3 is a perspective view of a coaxial steam-water jet nozzle,

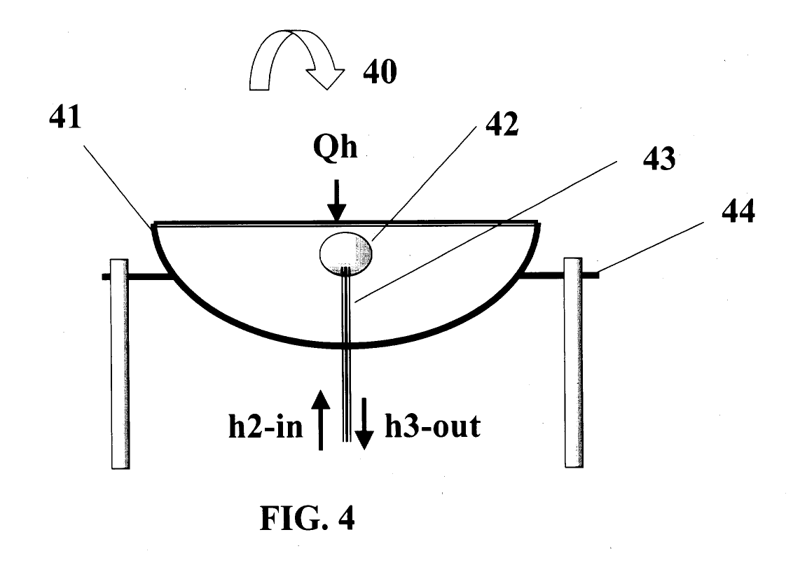

FIG. 4 is a perspective view of parabolic dish concentrator for residential use,

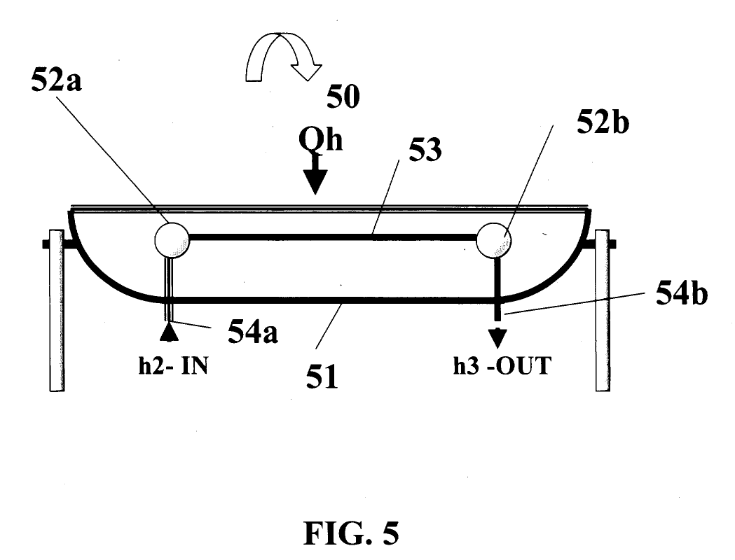

FIG. 5 is a perspective view of dish-trough concentrator for commercial use

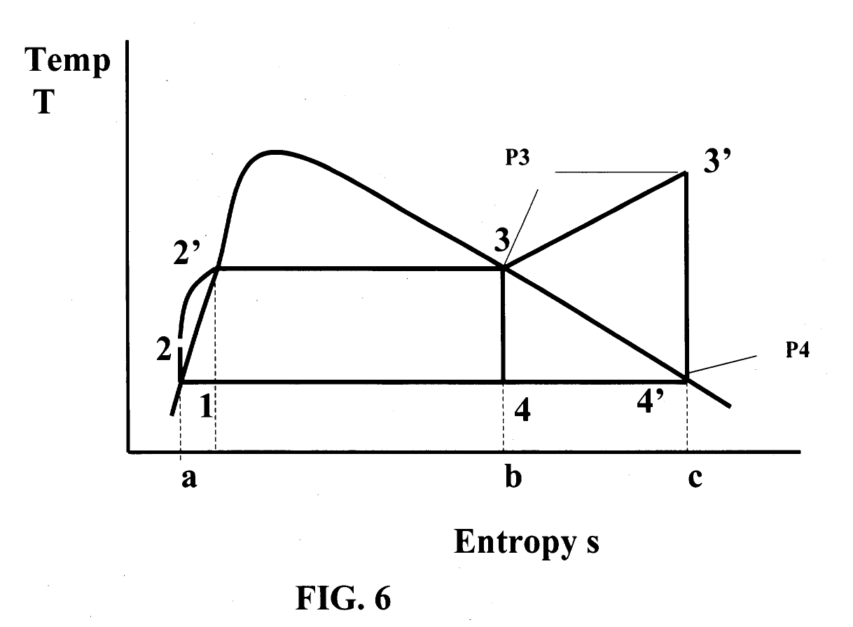

FIG. 6 is a Temperature—Entropy diagram representing the principle of steam rotary jet engine,

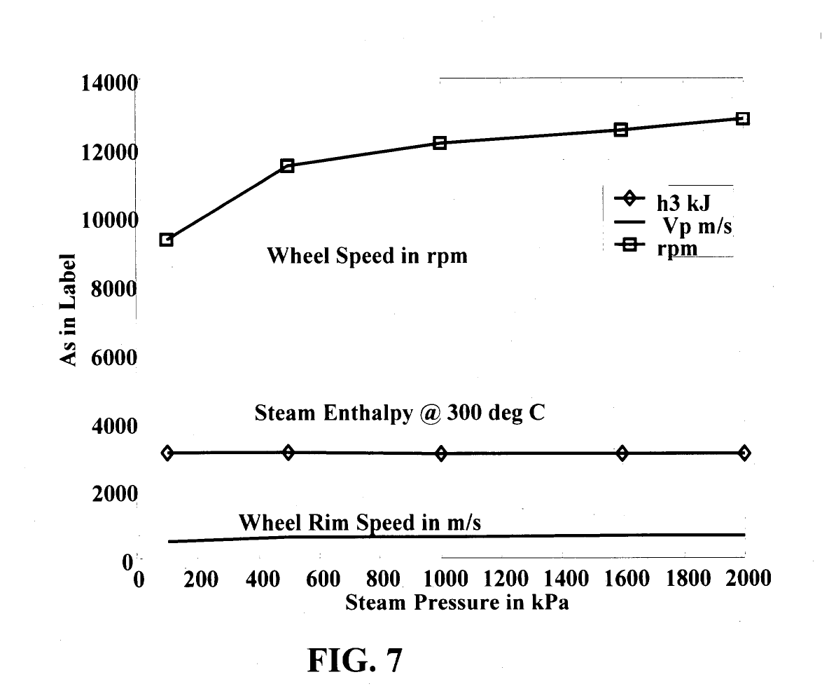

FIG. 7 is a plot showing disc speed, enthalpy and wheel rim speed vs. steam pressure,

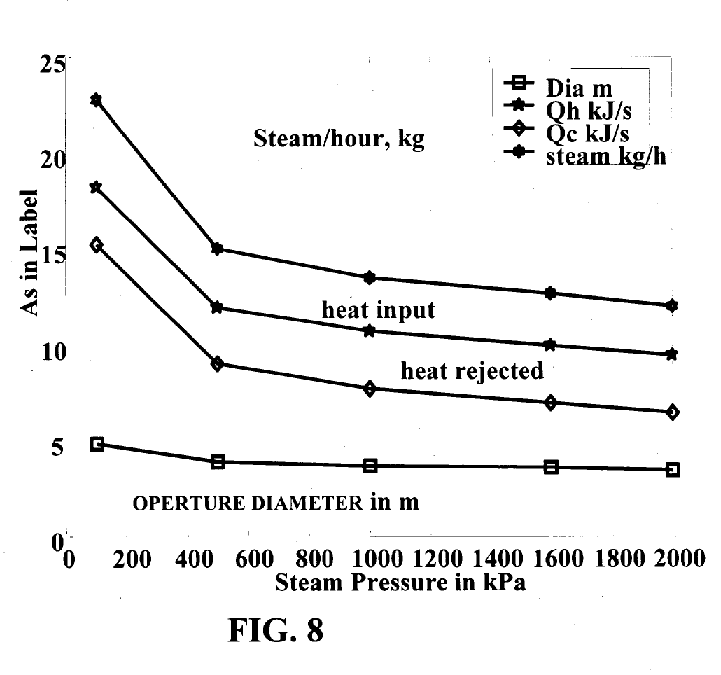

FIG. 8 is a plot showing concentrator dimension and steam input for 3 kW power output,

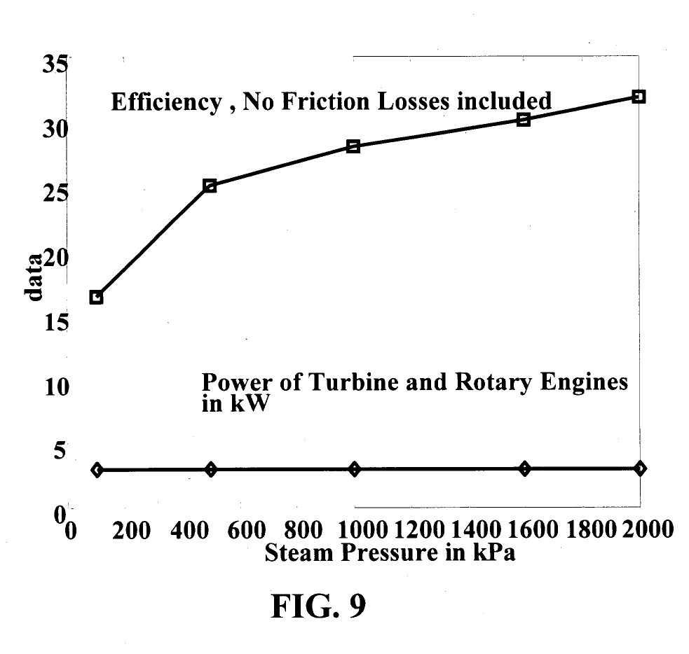

FIG. 9 is a plot of power and thermal efficiency of ideal rotary jet engine and the turbo engine

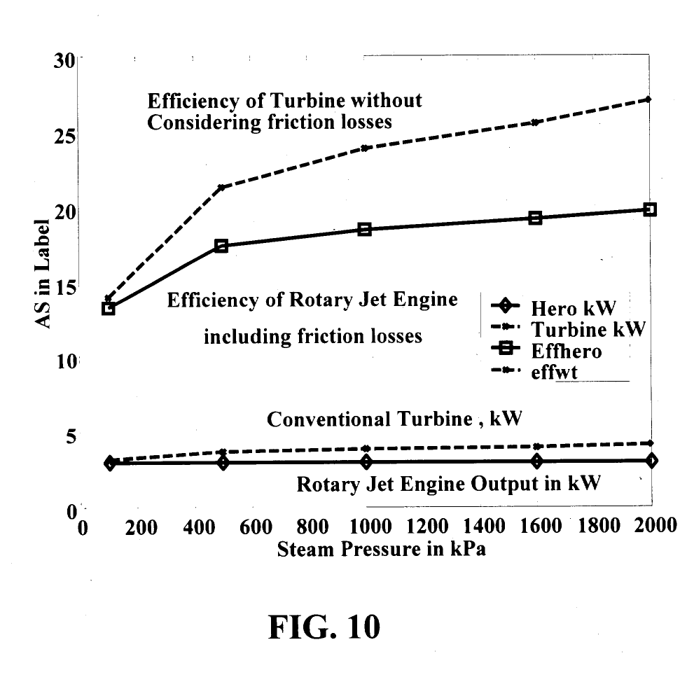

FIG. 10 is a plot of power and thermal efficiency of practical rotary jet engine and the turbo engine

### 2. REFERENCE NUMERALS

11 Solar concentrator

12 Solar Power system

13 electric output

14 condenser

15 water intake conduit from condenser

16 Pump

17 Rotary fluid coupler (multi-channel)

21 Power system framework

22 Disc

23 Coaxial shaft,

24 rotary fluid coupler

25 Electrical generator

26a and b Steam/water nozzles

27 recycling pump

28a, b cooling fluid inlet and out let

29 Condenser grill

31 steam nozzle

32 water nozzle

33 steam

34 water

35 Steam/water inlet base

41 Parabolic dish

42 Spherical boiler vessel

43 working fluid inlet/outlet

44 Sun tracking controller

51 parabolic dish-trough concentrator

52a, b Spherical boiler

53 Tube-boiler

54a,b working fluid inlet/out

### DETAILED DESCRIPTION OF THE PREFERRED EMBODIMENT

The novel featured characteristics of this invention are set forth in the appended claims. The invention itself may be best understood and its objects and advantages best appreciated by reference to the detailed description below in connection with the accompanying drawings. Although the present invention will be described with reference to the embodiment shown in the drawings, it should be understood that the present invention could be embodied in many alternate forms or embodiments. In addition, any suitable size, shape or type of elements or materials could be used.

FIG. 1 diagrammatically represents a micro solar thermal power to electrical power conversion unit 10 comprising a solar concentrator that heats the working fluid to steam 11, a solar power conversion system 12, a condenser 13, and a pump 16. Said solar concentrator heats the working fluid from liquid to steam/gas. The steam will be conveyed to the steam jets that cause torque to drive an electrical generator. As the high-pressure steam expands through the nozzle, it condenses to water at atmospheric pressure. This water will be recycled to the high-pressure boiler by means of a pump 16. Further, it should be noted that certain amount of water is drawn from the condenser by means of a conduit 15, to mix with the steam in order to reduce jet noise. The suction pressure created by the steam jet 31 is sufficient to draw the water from the condenser, without requiring additional pump. As shown in FIG. 3, steam 33 and water 34 will be mixed in the outer nozzle port 32, generating same thrust at reduced noise level. The jet noise decreases as the fifth power of the jet velocity ration. So, a 10 percent reduction in jet velocity reduces the noise by 50 percent.

Now referring now to FIG. 2, there is shown a cut-away view of a solar thermal power system 20, incorporating the features of the present invention. Said power system primarily consists of a disc 22, imbedded with plurality of micro steam jets 26a, 26b. Said disc is rotatably mounted on a supporting framework 21, by means of a coaxial shaft 23. An electrical generator 25 having an armature and rotor is driven by said jets. A dual port rotary fluid conveying inlet device 24 is provided on one end of said shaft, and thereby conveys steam and water from a stationary platform to said disc.

FIG. 4 40 shows an outline of parabolic dish concentrator 41, having a spherical steam boiler 42 mounted at its focal point, generally located below the rim due to safety consideration. Fluid inlet and outlet conduits 43 are denoted by arrows. A sun-tracking device 44 is used to realize maximum exposure to sun. This type of concentrators suggested for residential units. While hybrid solar concentrator shown in FIG. 5 50 are suggested for commercial and industrial building use. Here, two spherical vessels 52a,b are connected by means of tube boiler 53. Fluid inlet and outlet are denoted by 54a and 54b conduits. This device combines advantages of spherical and trough concentrators. The spillover effect of conventional troughs is avoided by the use of semi-spherical units at both ends. Thus, the thermal efficiency of this hybrid unit could be increased.

Working Principle of the Rotary Steam Jet Engine

FIG. 6 depicts an overview of the working principle of the rotary steam jet engine in terms of the temperature-entropy diagram. The foregoing discussion briefly outlines a mathematical basis with some examples. Referring to FIGS. 1 and 6 we denote the energy levels (entropy) by h per unit mass of steam or a working fluid. The saturated water in the condenser is at atmospheric pressure and designated as enthalpy level h₁.

A pump is used to transfer the water from the condenser to the high-pressure vessel in the concentrator at pressure p₂, and enthalpy h₂.

Thus the work done by the pump,

wₚ=v(p₂−p₁)/ηₚ (1)

where v is specific volume of water, m³/kg, and ηₚ is the pump efficiency.

The enthalpy of water entering the steam chamber is,

h₂=h₁+wₚ (2)

The solar concentrators supply heat Qₕ to the working fluid (water or ammonia) raising its enthalpy to

h₃=h₂+Qₕ (3)

The steam can be super heated to any desired temperature above the saturation point. This puts the steam at enthalpy level at h₃, on the T-s diagram. This steam can be expanded through a nozzle to h₄. Thus, the work done by a turbine can be written as, assuming an efficiency of η_{turb}

Turbine work

w_{T}=η_{turb}(h₃−h₄) (4)

The thermal efficiency of the turbine is the given by

ηₜₕₑᵣ=w_{T}/(h₃−h₂) (5)

Since entropy is constant during expansion, we have

s₃=s₄=s_{f4}+x.s_{fg4} (6)

Using steam tables, the steam condition x can be determined. Likewise, the enthalpy h₄ also can be computed as,

h₄=h_{f4}+x.h_{fg4} (7)

Finally the heat rejected in the condenser is given by

Q_{c}=h₄−h₁ (8)

This heat can be used to heat the buildings in cold seasons or cool the same building in hot seasons by the use refrigerant fluids and expanding. Thus, the thermal efficiency of the system can be enhanced. Discussion of co-generation is beyond the scope of this study.

Next, we shall compute the jet velocity and the surface area of the solar concentrator. The jet velocity is given by

Vⱼ=sqrt(2 *(h₃−h₄)) (9)

Thrust,

Fᵢ=qₛVⱼ, where, qₛ is th emass rate of steam (10)

The power generated by the rotary jet engine (accounting for pump and drag losses) can be written as,

P=qₛ(VⱼVₚ−wₚ)−C₁Vₚ³ (11)

or

qₛ=(P+C₁Vₚ³)/(VⱼVₚ−wₚ) (12)

where, Vₚ=ω.R is the peripheral velocity of the disc, and C₁ is a constant related to the aerodynamic drag of the disc. Equation (12), (assuming various values of the disc speed, Vₚ) can be solved for the minimum value of steam, qₛ and the disc speed Vₚ.

Then, the thermal efficiency of the Micro Solar Thermal Power system is given by,

η_{H}=P/(h₃−h₄) (13)

The jet velocity, Vⱼ, is generally supersonic, results in noise. The noise can be reduced by a significant margin by adding water to the steam jet stream. Since the momentum is conserved, the jet thrust remains the same, while the noise reduces as the 5-8^{th} (depending on Mach number) power of the velocity ratio. For example, a 10% reduction in the jet velocity could reduce the noise by 50%. As depicted in FIG. 1, the water can be drawn from the condenser by means of the suction generated by the expanding steam in the nozzle (FIG. 3). Injector nozzles are made for this type of applications.

Next, we compute the required aperture area:

A=(qₛ.Qh)/Insolation (14)

Where, insolation is the amount solar power, (e.g. watts/m\hat{ }2) is available at a site.

To demonstrate the solar thermal efficiency of the Hero's engine adaptation, a simple example was considered as presented in the next section.

### EXAMPLE

| | |
|---|---|
| Power = | 3 kW |
| Steam Temperature = | 300° C. |
| Steam Pressure = | 500 through 2000 kPa |
| Conventional Turbine efficiency = | 85% |
| Drag coefficient of the disc = | 0.002 |
| Disc diameter = | 0.5 m |
| Insolation level = | 1 kW/m\hat{ }2 |

For the typical data selected as above, FIG. 7 shows the working enthalpy level in kJ/kg, the rotary engine disc speed in rpm and the peripheral speed in m/sec. While FIG. 8 shows the parabolic dish aperture diameter in meter, Heat input and rejection in kJ/sec, and amount of steam required in kg/hour. All data are presented for various values of the steam pressure in kPa. From the plot we note that the proposed engine Is need not operate at high pressure as in the case of conventional engines. Even at 500 kPa (˜150 psi) pressure, a 4.7 meter diameter parabolic dish can deliver 3 kW power. The thermal efficiency of the rotary jet engine is seen to be in par with the conventional Stirling and the turbine engines (see FIGS. 9 and 10), but having fewer moving parts and simplicity.

From the foregoing, consider some of the advantages of the proposed micro solar thermal power system:

1. Uses a single rotating disc, hence it is simple to manufacture and maintain,

12. It is a lightweight engine and costs less.

It should be understood that the foregoing description is only illustrative of the invention. Various alternatives and modifications can be devised by those skilled in the art without departing from the invention. Accordingly, the present invention is intended to embrace all such alternatives, modifications and variances, which fall within the scope of the appended claims.

What is claimed is:

1. A micro solar thermal power to electric power conversion apparatus comprising:
(a) Plurality of steam jet nozzles firmly imbedded along the periphery of a disc, which is rotatably housed inside a supporting framework;
(b) An electric generator rotatably coupled to said disc,
(c) A condenser that collects the expanding steam jet,
(d) A pump that transfers the fluid from condenser to the boiler at high pressure
thereby, providing an apparatus to convert solar thermal energy to electrical energy for use in residential and commercial buildings.

2. A micro solar thermal power to electric power conversion apparatus of claim 1, wherein a hybrid solar concentrator comprising a parabolic trough having semi-dish end enclosures, whereby the benefit of point concentration and line concentration is made possible to raise the enthalpy of the working fluid sufficient enough to generate electrical power for residential and commercial buildings.

3. A micro solar thermal power to electric power conversion apparatus of claim 1, wherein plurality of steam nozzles imbedded along the periphery of a rotatably mounted disc drives an electrical alternator/generator that produces electrical power.

4. Said nozzles of claim 3, receive high-pressure steam and water by means of a coaxial rotary fluid coupler.

5. Said nozzles of claim 3, mix steam and water in a predetermined ratio to reduce jet noise without loss of thrust.
